(19) United States
(12) Patent Application Publication
(10) Pub. No.: US 2004/0052245 A1
(43) Pub. Date: Mar. 18, 2004

(54) Automatic re-origination method for multimedia or voice call in mobile station

(75) Inventor: Do-Hun Kwon, Yongin-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/353,586

(22) Filed: Jan. 29, 2003

(30) Foreign Application Priority Data
Sep. 14, 2002 (KR) 2002-55960

(51) Int. Cl. H04L 12/66

(52) U.S. Cl. 370/352

(57) ABSTRACT

Multimedia or voice call originating method in a mobile station which can originate both multimedia and voice calls. The call originating method comprises: trying to originate one of a multimedia call and a voice call selected by a user; examining whether the call origination step has succeeded; and if failure is detected in the examination step, automatically trying to originate the other one of the multimedia call and the voice call, which option was not tried in the call origination step.

### PRIORITY

This application claims priority to an application entitled, “Automatic Re-origination Method for Multimedia or Voice Call in Mobile Station” filed in the Korean Intellectual Property Office on Sep. 14, 2002 and assigned Serial No. 2002-55960, the contents of which are hereby incorporated by reference.

### BACKGROUND OF THE INVENTION

1. Field of the Invention

The present invention relates to an originating method in a mobile station.

2. Description of the Related Art

Recently, mobile stations install an interactive multimedia call function in addition to a simple voice call. This allows visual communication between mobile stations which support voice and moving picture via Voice over Internet Protocol (VoIP) in addition to the moving picture via wireless packet network over Mobile Internet Protocol (MIP) and/or Simple Internet Protocol(SIP) and two-way video protocol (H.323, H.324 m, and so on) in addition to the basic voice conversation function.

In general, when a call connection is not established owing to a network condition or any other reason, the user of the mobile station manually retries call origination. For example, a user of a general mobile station (having a voice call function) tries voice call origination again when a previous voice call is not connected. Also, when a multimedia call is not connected, a multimedia station user retries multimedia call origination. When the voice or multimedia call is not connected as above, it is troublesome and inconvenient, from the viewpoint of the user, to manually perform a call originating process again through his/her mobile station, including selection of a type of call.

### SUMMARY OF THE INVENTION

The present invention has been made to solve the foregoing problems and it is therefore an object of the present invention to provide a call re-origination method, by which when one particular type of call connection is not established, a mobile station capable of performing at least two types of call functions automatically attempts to originate another type of call connection.

According to an aspect of the invention for achieving the above object, there is provided a multimedia or voice call originating method in a mobile station which can originate both multimedia and voice calls, the method comprising the steps of: attempting to originate one of a multimedia call and a voice call, as selected by a user; examining whether the selected call origination step has succeeded; and if failure is detected in the examination step, automatically attempting to originate the other one of the multimedia call and the voice call.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a communication network utilizing the invention;

FIG. 2 is a flowchart illustrating a registration process of a multimedia subscription performed by a mobile station of the invention;

FIG. 3 is a flowchart illustrating a process of originating multimedia and voice calls according to a preferred embodiment of the invention;

FIG. 4 is a flowchart illustrating a process of originating multimedia and voice calls according to an alternative embodiment of the invention;

FIG. 5 is a flowchart illustrating a process of originating multimedia and voice calls according to another alternative embodiment of the invention;

FIG. 6 is a flowchart illustrating a process of originating multimedia and voice calls according to yet another alternative embodiment of the invention; and

FIG. 7 illustrates a structure of a keypad of the invention.

### DETAILED DESCRIPTION OF THE PREFERRED EMBODIMENT

The following detailed description will present a preferred embodiment of the invention in reference to the accompanying drawings, in which well-known functions or constructions will not be described in detail since they would unnecessarily obscure the understanding of the invention.

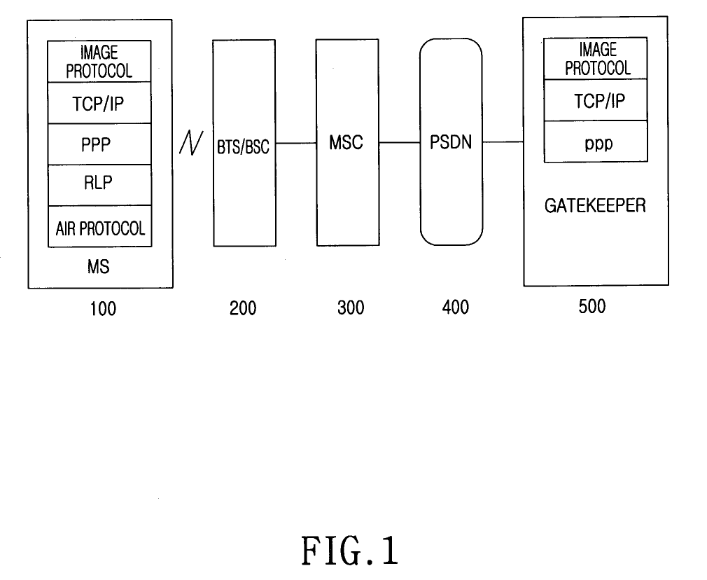

FIG. 1 is a block diagram of a communication network utilizing the invention.

A Mobile Station (MS) 100 includes, for example, a portable telephone or Personal Digital Assistant (PDA). The MS 100 capable of originating both multimedia and voice calls has software such as image protocol, Transmission Control Protocol/Internet Protocol (TCP/IP), Point-to-Point Protocol (PPP), Radio Link Protocol (RLP) and air protocol.

A Base-station Transceiver Subsystem (BTS)/Base Station Controller (BSC) 200 commonly designates a BTS and a BSC for the sake of convenience. The BTS serves to link between mobile stations and a switching center in a mobile communication network, and functions to perform wireless access with the mobile station, maintain synchronization and allocate/de-allocate a traffic channel. The BSC is positioned between the switching center and base stations, and performs various functions such as base station operation, management of hardware and software service state in the base station, allocation and construction of sources regarding call traffic, collection of information related to base station operation and monitoring of base station operation and sub-equipment related to detected failure. The BSC also allows handoff between the base stations within the same BSC coverage.

A Mobile Switching Center (MSC) 300 serves to link between Public Switched Telephone Network (PSTN) and the mobile communication network. The MSC 300 is located in the center of the mobile communication network to connect with the BTS/BSC 200, a Home Location Register (not shown) and so on, thereby functioning to establish a voice or non-voice speech path with the MS 100 as well as to perform switching center operation and maintenance.

A Packet Data Serving Node (PDSN) 400 functions to provide data service of the mobile communication network. Currently, the PDSN is used in a Code Division Multiple Access (CDMA) network for providing a super high wireless Internet service such as 2-generation wireless service, 2.5-generation wireless service or International Mobile Telecommunication-2000 (IMT-2000).

A gatekeeper 500 is connected to the PDSN 400, and operates as a server for controlling visual communication.

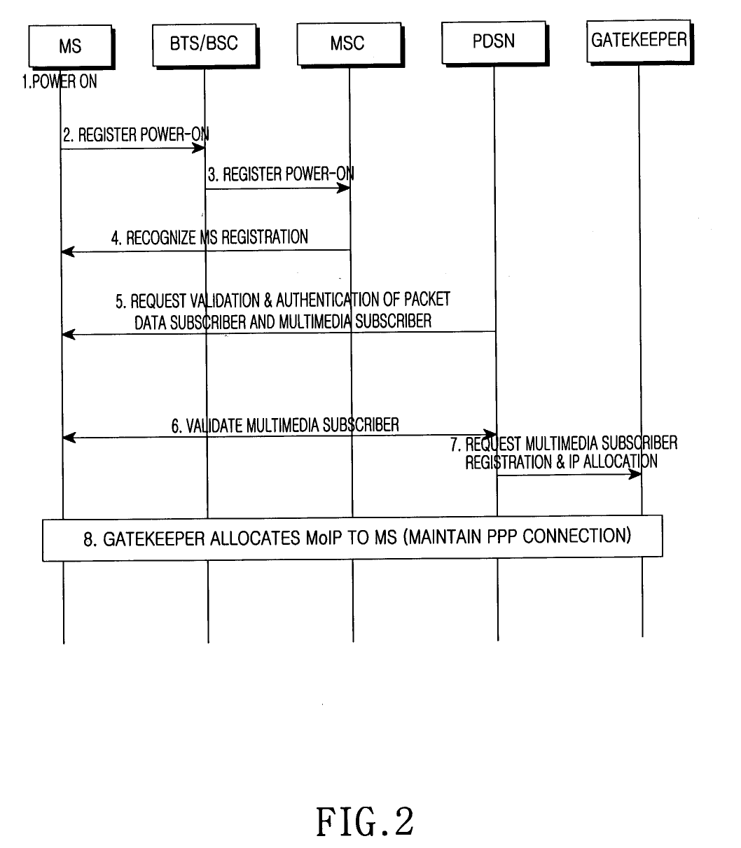

FIG. 2 is a flowchart illustrating a registration process of a multimedia subscriber performed by a mobile station of the invention.

When a user powers on the MS 100 (step 1), the MS 100 registers power-on in the BTS/BSC 200 (step 2). The BTS/BSC 200 registers power-on in the MSC 300 (step 3). The MSC 300 recognizes registration of the MS 100 (step 4). At completion of validation of a multimedia subscriber between the PDSN 400 and the MS 100 (steps 5, 6), the PDSN 400 requests the gatekeeper 500 for registration of the multimedia subscriber and IP allocation (step 7). Then, the gatekeeper 500 allocates a Multimedia over IP (MoIP) to the MS 100 and maintains PPP connection (step 8).

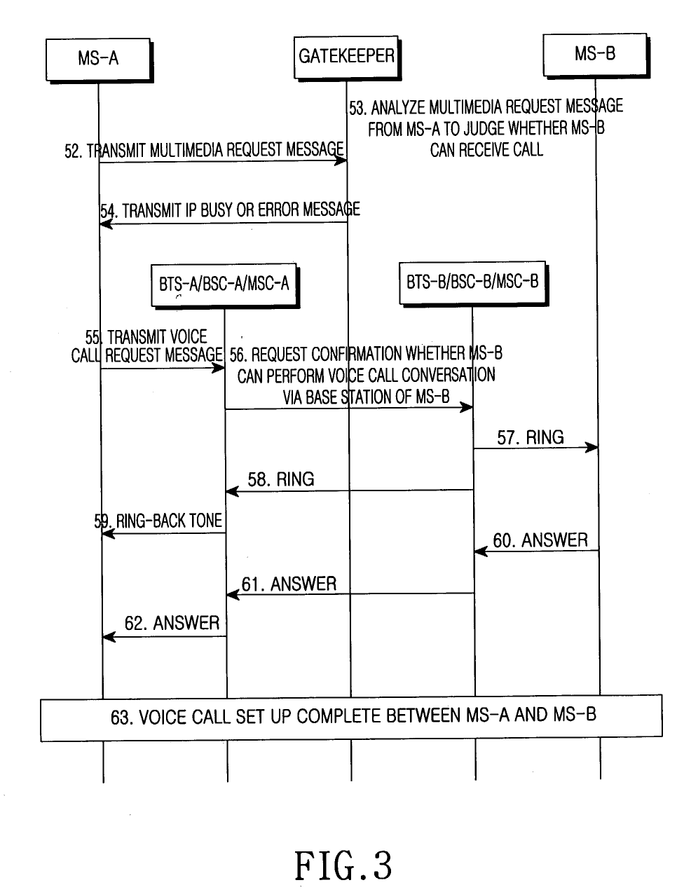

FIG. 3 is a flowchart illustrating a process of originating multimedia and voice calls according to a preferred embodiment of the invention.

An MS-A transmits a multimedia request message to the gatekeeper in step 52. A telephone number and a multimedia button are inputted to transmit the multimedia request message. The gatekeeper analyzes the multimedia request message from the MS-A, and determines whether the MS-B can receive a multimedia call in 53. If the gatekeeper determines that MS-B cannot receive the call, the gatekeeper transmits an IP busy message (e.g., owing to existing multimedia conversation or data communication by MS-B) or an error message into the MS-A in step 54. The error message may mean a message informing that an MS-B is incapable of receiving a multimedia call, has not made any answer or the call has failed owing to malfunction of a network or equipment. Otherwise, even though it is not indicated, it is possible that the gatekeeper has not transmitted the answer according to a reason similar to the above.

At failure of the multimedia call in step 54, the MS-A transmits a voice call request message into its servicing BTS, BSC and MSC (collectively referred to as BTS-A/BSC-A/MSC-A) in step 55. (Hereinafter the MSC and the BTS/BSC will be commonly designated as “base station” and operational processes between the BTS/BSC and the MSC will be omitted for the sake of convenience.) The voice call request message contains a telephone number of the MS-B. In step 56, the BTS-A/BSC-A/MSC-A requests whether the MS-B can perform voice conversation via a base station BTS-B/BSC-B/MSC-B servicing the MS-B. The BTS-B/BSC-B/MSC-B transmits a ring to the MS-B in step 57, and to the BTS-A/BSC-A/MSC-A in step 58. The BTS-A/BSC-A/MSC-A transmits a ring-back tone to the MS-A in step 59. If the MS-B transmits an answer signal into the BTS-B/BSC-B/MSC-B in step 60, the BTS-B/BSC-B/MSC-B also transmits the answer signal into the MS-A in step 62.

In that case, a voice call set up is completed between the MS-A and the MS-B in step 63.

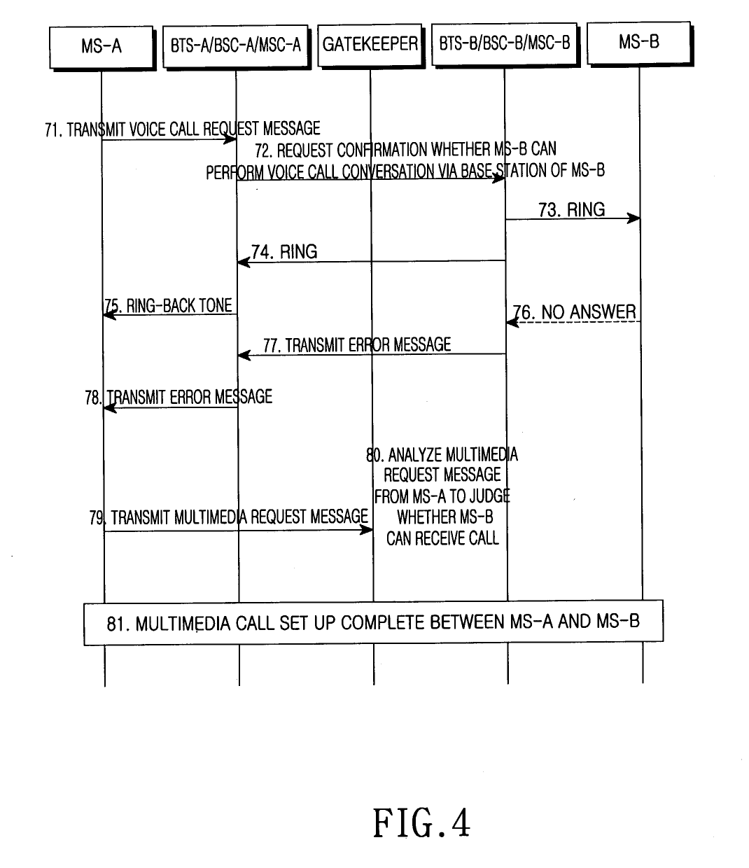

FIG. 4 is a flowchart illustrating a process of originating multimedia and voice calls according to an alternative embodiment of the invention.

The MS-A transmits a voice call request message into the base station BTS-A/BSC-A)MSC-A of the MS-A in step 71. The voice call request message contains a telephone number of the MS-B. The BTS-A/BSC-A/MSC-A requests confirmation whether the MS-B can perform voice conversation via the BTS-B/BSC-B/MSC-B of the MS-B in step 72. The BTS-B/BSC-B/MSC-B transmits a ring to the MS-B in step 73, and to the BTS-A/BSC-A/MSC-A in step 74. The BTS-A/BSC-A/MSC-A transmits a ring-back tone to the MS-A in step 75. If the MS-B does not transmit an answer into the BTS-B/BSC-B/MSC-B in step 76, the BTS-B/BSC-B/MSC-B transmits an error message into the BTS-A/BSC-A/MSC-A in step 77. Then the BTS-A/BSC-A/MSC-A also transmits an error message to the MS-A in step 78. According to the above-illustrated example, the error message means a message informing that the MS-B has not answered. In addition, the error message may inform that the call has failed owing to malfunction of the network or equipment, MS-B is busy, a voice-mail connected to the voice call function has picked up, etc.

At failure of the voice call as above, the MS-A transmits a multimedia request message into the gatekeeper in step 79. The multimedia request message including the receiving telephone number is automatically generated by MS-A to transmit the multimedia request message. The gatekeeper analyzes the multimedia request message from the MS-A, and determines whether the MS-B can receive a call in step 80. If it is determined that the MS-B can receive the call, multimedia call set up is completed between the MS-A and the MS-B in step 81.

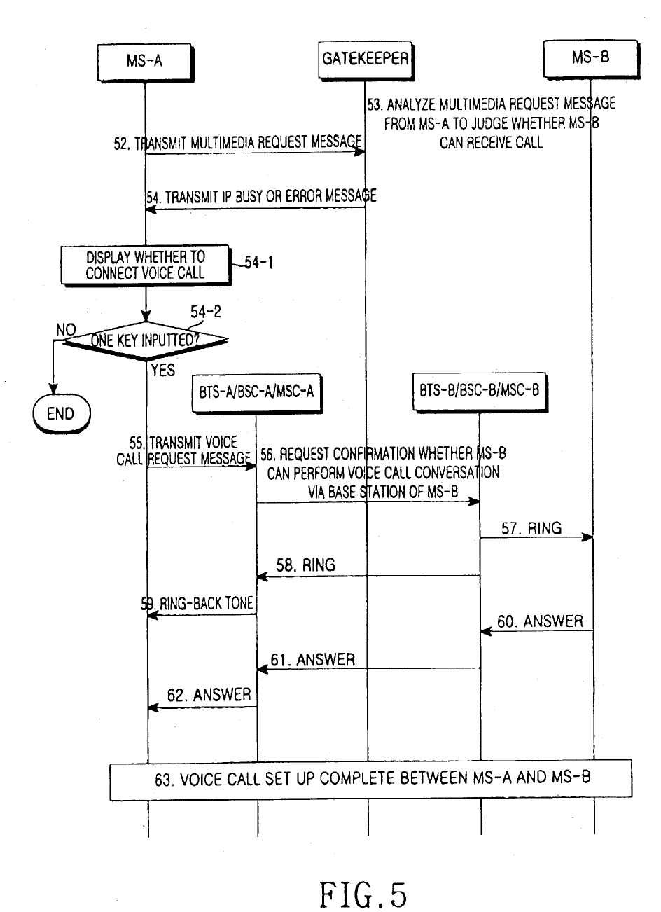

FIG. 5 is a flowchart illustrating a process of originating multimedia and voice calls according to another alternative embodiment of the invention.

The process of this embodiment performs call re-origination, like the above preferred embodiment (shown in FIG. 3), but uses a manual prompt for voice call origination. That is, after the multimedia call request fails, the MS-A displays a message for questioning whether a user wants voice call connection or not, and thus the user can recognize circumstances from the displayed message and thus input a key requesting connection in steps 54-1 and 54-2. The key for requesting connection may be the # key or a single key which is predesignated to allow the user to express that he/she wants to connect a voice call.

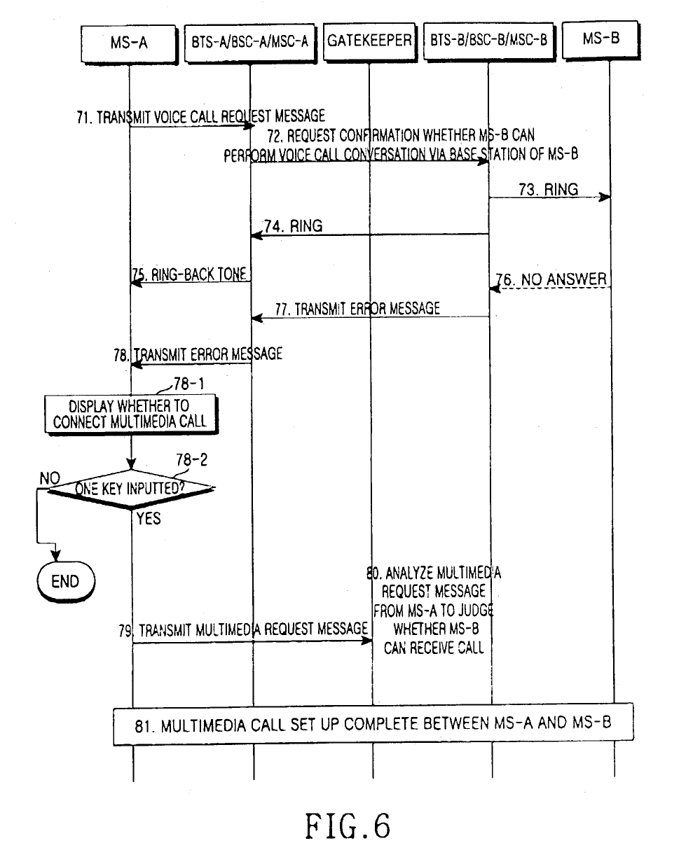

FIG. 6 is a flowchart illustrating a process of originating multimedia and voice calls according to yet another alternative embodiment of the invention.

The process of this embodiment performs call re-origination, like the above preferred embodiment (shown in FIG. 4), but uses a manual prompt for multimedia call origination. That is, after the voice call fails, the MS-A displays a message for questioning whether a user wants multimedia call connection or not, and thus the user can recognize circumstances from the displayed message and thus input a key requesting connection in steps 78-1 and 78-2.

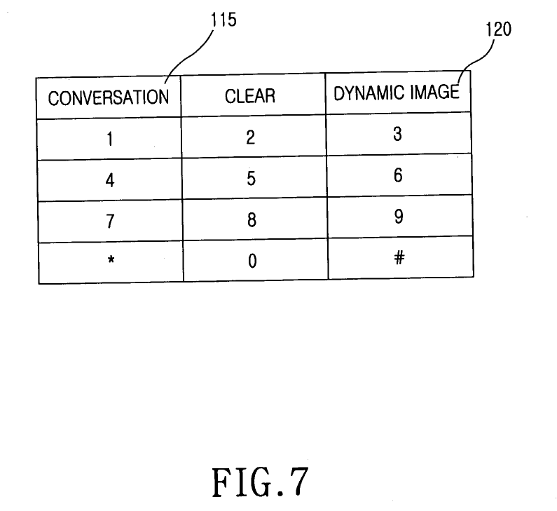

FIG. 7 illustrates a structure of a keypad of the invention.

In attempting a common call, a telephone number is inputted by pressing number keys and then a conversation key 115 is pressed to transmit a signal. In originating a multimedia call, a multimedia button 120, number keys corresponding to the telephone number and the conversation key 115 are pressed to transmit a signal. That is, in trial of the multimedia call, a separate multimedia button 120 is pressed to differentiate the multimedia call attempt from the common call attempt.

According to the present invention as set forth above, when multimedia set up is not established, a mobile station also supporting a voice call function can automatically request the voice call thereby automatically connecting the call. On the contrary, when general call set up is not established, a mobile station also supporting a multimedia call function can automatically try multimedia call connection. Further, at failure of multimedia or voice call connection, where a mobile station supports both of multimedia and voice call functions, the mobile station can automatically originate a multimedia or voice call again requesting call connection. Therefore, a user can use the mobile station more conveniently. Furthermore, a keypad comprises a multimedia-dedicated key allowing key application for multimedia call separate from voice call. That is, convenience of key input is enhanced since it is not necessary for the user to memorize a complicated key combination which is made for discrimination from voice call input.

While this invention has been described in connection with the preferred embodiments in the specification of the invention, it is also understood that various modifications and variations can be made without departing from the scope of the invention, which is not restricted to the above described embodiments but shall be defined by the appended claims and equivalents thereof.

What is claimed is:

1. A multimedia or voice call originating method in a mobile station, the method comprising the steps of:
(a) attempting to originate one of a multimedia call and a voice call selected by a user;
(b) examining whether the selected call origination succeeded or failed in step (a); and
(c) if failure is detected in the step (b), automatically attempting to originate the other one of the multimedia call and the voice call, which was not attempted in step (a).

2. A multimedia or voice call originating method in a mobile station, the method comprising the steps of:
(a) attempting to originate one of a multimedia call and a voice call selected by a user;
(b) examining whether or not call origination has succeeded in the step (a);
(c) if failure is detected in the step (b), questioning the user whether the user wants to originate the other one of the multimedia call and the voice call, which was not attempted in step (a); and
(d) upon detecting an answer inputted from the user requesting to originate the other call which was not attempted in the step (a), attempting to originate the other one of the multimedia call and the voice call, which was not attempted in the step (a).

3. A multimedia or voice call originating method in a mobile station in accordance with claim 2, wherein the answer is inputted via a single key in the step (d).

4. A multimedia or voice call originating method in a mobile station, the method comprising the steps of:
(a) transmitting, by a first mobile station, a multimedia request message into a gatekeeper to originate a multimedia call to a second mobile station;
(b) examining, by the gatekeeper, the state of the second mobile station; and
(c) if it is determined that the second mobile station cannot receive the multimedia call in step (b), automatically originating a voice call to the second mobile station by the first mobile station.

5. A multimedia or voice call originating method in a mobile station in accordance with claim 4, wherein the step (c) comprises:
transmitting, by the first mobile station, a voice call request message to a base station of the first mobile station;
requesting via a base station of the second mobile station whether the second mobile station can perform voice conversation;
transmitting, by the base station of the second mobile station, a ring to the second mobile station and the base station of the first mobile station, respectively;
transmitting, by the base station of the first mobile station, a ring-back tone to the first mobile station; and
transmitting an answer to the base station of the second mobile station by the second mobile station, an answer to the base station of the first mobile station by the base station of the second mobile station, and an answer to the first mobile station by the base station of the first mobile station, in order to complete voice call set up between the first and second mobile stations.

6. A multimedia or voice call originating method in a mobile station in accordance with claim 5, wherein the voice call request message contains a telephone number of the second mobile station.

7. A multimedia or voice call originating method in a mobile station, the method comprising the steps of:
(a) transmitting, by a first mobile station, a voice call request message to a base station of the first station requesting voice conversation with a second mobile station;
(b) requesting whether the second mobile station can perform voice conversation by the base station of the first mobile station to a base station of the second mobile station;
(c) transmitting a ring by the base station of the second mobile station to the second mobile station and the base station of the first mobile station, respectively;
(d) transmitting a ring-back tone from the base station of the first mobile station to the first mobile station; and
(e) if the second mobile station does not answer, automatically trying to originate a multimedia call to the second mobile station.

8. A multimedia or voice call originating method in a mobile station in accordance with claim 7, wherein the step (e) comprises:
transmitting a multimedia call request message by the first mobile station to a gatekeeper in order to originate a multimedia call to a second mobile station;
examining, by the gatekeeper, the state of the second mobile station; and
if it is determined that the second mobile station can receive the call in the examination step, completing multimedia call set up between the first and second mobile stations.

9. A multimedia or voice call originating method in a mobile station in accordance with claim 8, wherein the multimedia call request message contains a telephone number of the second mobile station and a dynamic image.
